(19) United States
(12) Patent Application Publication
(10) Pub. No.: US 2005/0201685 A1
(43) Pub. Date: Sep. 15, 2005

(54) Optical cavity having increased sensitivity

(76) Inventors: Christopher P. Yakymyshyn, Seminole, FL (US); William Q. Law, Beaverton, OR (US); William A. Hagerup, Portland, OR (US)

Correspondence Address: WILLIAM K. BUCHER;TEKTRONIX, INC., P O BOX 500 (50-LAW), BEAVERTON, OR, 97077-0001, US

(21) Appl. No.: 11/077,705

(22) Filed: Mar. 10, 2005

Related U.S. Application Data
(60) Provisional application No. 60/552,334, filed on Mar. 10, 2004.

(51) Int. Cl. G02B 6/26

(52) U.S. Cl. 385/40

(57) ABSTRACT

An optical cavity having an electro-optic material disposed between opposing optically reflective material has an electrode structure with first and second apertures disposed generally parallel to an optical signal propagating within the electro-optic material. Electrically conductive material is disposed within the apertures coupling an electrical signal to the optical cavity.

### CROSS-REFERENCE TO RELATED APPLICATION

This application claims the benefit of the U.S. Provisional Application No. 60/552,334, filed Mar. 10, 2004.

### BACKGROUND OF THE INVENTION

The present invention relates generally to optical cavities and more particularly to an optical cavity having increased sensitivity to applied electrical fields.

Electro-optic material is a class of inorganic and organic crystals where the index of refraction of the material changes in response to electromagnetic energy applied to the material. Such material may be used in the production of optical devices, such as optical cavities, optical switches, optical limiters, optical modulators and the like. In it simplest form, an optical signal, such as the output of a laser or the like, is launched into the electro-optic material having length and widths in the millimeter range and thicknesses in the tenths of millimeter range. The diameter of the optical path of the optical signal within the electro-optic material generally ranges from ten to a few hundreds microns across. Electrodes are formed on opposing surfaces of the electro-optic material that are parallel to the optical path of the signal passing through the electro-optic material. An electrical signal is applied to the electrodes which varies the index of refraction of the electro-optic material as a function of the variations of the electrical signal. The variations of the index of refraction of the electro-optic material alters the optical signal propagating through the electro-optic material.

Optically reflective material may be disposed on opposing sides of the electro-optic material to form an optical cavity. A Fabry-Perot etalon is an example of such an optical cavity. The reflectivity of the optically reflective material on the opposing sides of the electro-optic material is defined by the particular application of the optical cavity. The optical signal passes through at least one of the optically reflective materials and into the electro-optic material. Electrodes are formed on opposing surfaces of the electro-optic material that are parallel to the optical path of the optical signal. An electrical signal applied to the electrodes varies the index of refraction of the electro-optic material as a function of the variations in the electrical signal.

The strength of the electric field distribution within the electro-optic material is a function of the distance between the opposing electrodes and the amplitude of the applied electrical signal. The strength of the electric field is the inverse of the distance separation of the electrodes. As the distance between the electrodes decreases, the strength of the electric field between them increases. As the distance decreases, the magnitude of the electrical signal can decrease to generate the same amount of change in the index of refraction.

Currently, the minimum overall dimensions of the electro-optic material used in optical devices and cavities is limited by the practical size at which the material can be handled resulting in electrodes that are positioned at a substantial distance from the optical path of the optical signal. This results in optical devices having low sensitivity to the applied electrical signal.

U.S. Pat. No. 5,353,262 describes an ultrasound optical transducer that generates an optical signal the frequency of which varies in correspondence with acoustic energy incident on the transducer. The transducer includes a housing in which is disposed a signal laser. The signal laser is preferably a microchip laser, microcavity laser or the like. The signal laser has an optical cavity disposed between first and second reflectors and in which a lazing medium (also known as a gain crystal) is disposed. The reflectors are disposed on opposing plane-parallel surfaces of the lasing medium. An optical source injects an optical signal at a first frequency into the signal laser, which generates a second output signal at a second frequency. Acoustic energy impinging on the transducer causes the index of refraction of the optical cavity to change which in turn, causes the frequency of the signal laser to change. The frequency modulated optical signal from the signal laser is coupled to signal processing assembly that generates an output signal corresponding to the amplitude of the incident acoustic energy for use in imaging and analysis. An alternative embodiment is described where a piezoelectric device is positioned on the transducer for converting the acoustic energy into an electrical signal. The electrical signal is applied to electrodes on the signal laser. The electrical signal causes a change in the index of refraction of the optical cavity as a function of the acoustic energy applied to the piezoelectric device.

U.S. Pat. No. 4,196,396 describes the use of a Fabry-Perot enhanced electro-optic modulator to produce a bistable resonator that could be used as an optical switch, optical limiter, or optical memory device. A further embodiment taught by the '396 patent is an optical amplifier. The reference teaches the use of high voltage signals in the thousand voltage range to change the index of refraction of the electro-optic material in the Fabry-Perot cavity. Such a system does not lend itself for small signal probing applications.

U.S. Pat. No. 5,394,098 describes the use of longitudinal Pockels effect in an electro-optic sensor for in-circuit testing of hybrids and circuits assembled on circuit boards. In one embodiment, a layer of electro-optic material is disposed between opposing layers of optically reflective materials that include electrically conductive layers. The optically reflective layer having highest reflectivity to an applied optical signal is placed in contact with a conductor on the circuit board. The other optically reflective layer is coupled to electrical ground. An optical signal from a laser is applied orthogonal to the optically reflective layers on the electro-optic material. An electrical signal on the conductor of the circuit board produces a voltage potential difference across the optically reflective layers which varies the refractive index of the electro-optic material. A drawback to this design is that the orientation of the polarized optical signal is orthogonal to the orientation of the electromagnetic field producing the Pockels effect in the electro-optic material. This reduces the sensitivity of the measured electrical signal. Further, forming electrically conductive layers on the opposing sides of the electro-optic material produces capacitive and inductive effects in the electro-optic sensor that limits the useful bandwidth of the system.

What is needed is an electrically controlled electro-optic cavity having improved sensitivity to applied electrical signals. The electrically controlled electro-optic cavity is preferably implemented as electrically controlled Fabry-Perot cavity.

### SUMMARY OF THE INVENTION

Accordingly, the present invention is directed to an optical cavity having an electro-optic material disposed between opposing optically reflective material. The optical cavity has first and second apertures formed in at least one of the optically reflective material and at least a portion of the electro-optic material. The first and second apertures are on opposing sides and generally parallel to a received optical signal propagating within the electro-optic material. Electrically conductive material is disposed within the first and second apertures. The first and second apertures are preferably disposed adjacent to the optical path of the optical signal propagating within the electro-optic material. Electrically conductive contacts may be formed on an exterior surface of the optical cavity with one of the contacts electrically coupled to the electrically conductive material disposed in the first aperture and the other contact electrically coupled to the electrically conductive material disposed in the second aperture. A termination resistor may be electrically coupled across the respective electrically conductive contacts coupled to the electrically conductive material disposed in the first and second apertures. The termination resistor may also be electrically coupled across the electrically conductive material disposed in the first and second apertures.

The electro-optic material preferably has X, Y, and Z optical axes and the received optical signal propagates generally parallel to one of the optical axes and first and second apertures are generally parallel to same optical axis. The propagation path of the optical signal and the first and second apertures lay on a plane defined by the optical axis parallel to the propagation path of the optical signal and the first and second apertures and one of the other two optical axes. The electro-optic material may be a Y-cut or X-cut crystal with the first and second apertures respectively parallel to the Y optical axis or the X optical axis and the optically reflective material disposed on the cut crystal faces. The X, Y and Z optical axes of the electro-optic material may be mutually perpendicular to each other or have one or more optical axes at oblique angles to each other.

The objects, advantages and novel features of the present invention are apparent from the following detailed description when read in conjunction with appended claims and attached drawings.

### BRIEF DESCRIPTION OF THE DRAWINGS

FIGS. 1A-1C illustrate alternative electrode configurations of the electrode structure for optical cavity according to the present invention.

FIGS. 2A-2E illustrate alternative contact configurations for the electrode structure in the optical cavity according to the present invention.

FIGS. 3A-3B illustrate alternative embodiments of the optical cavity according to the present invention.

### DETAILED DESCRIPTION OF THE PREFERRED EMBODIMENT

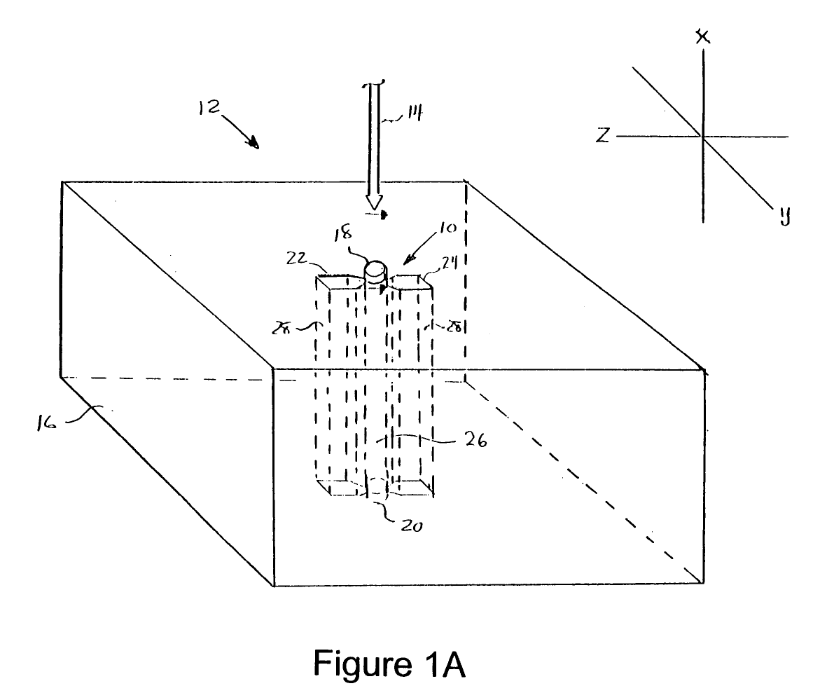

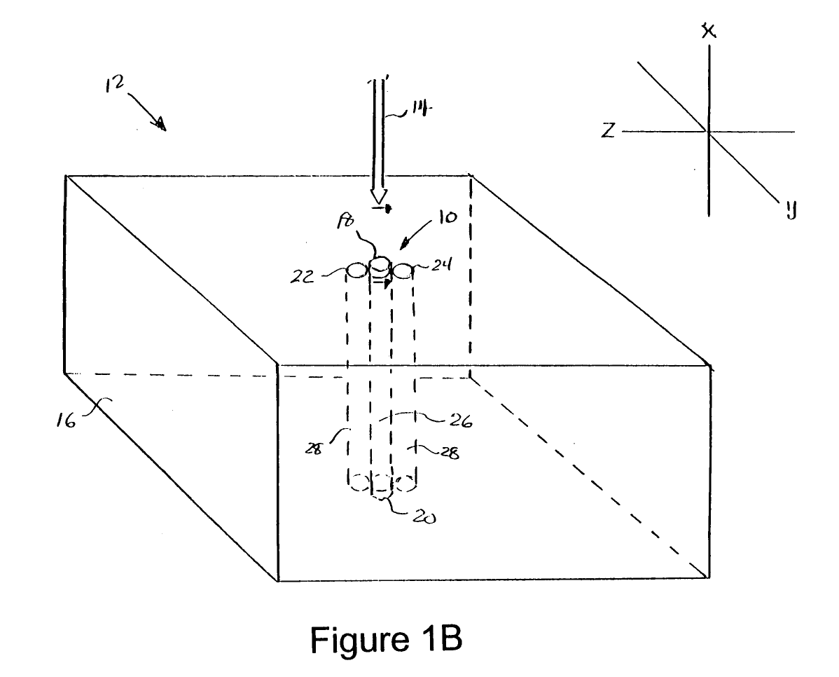

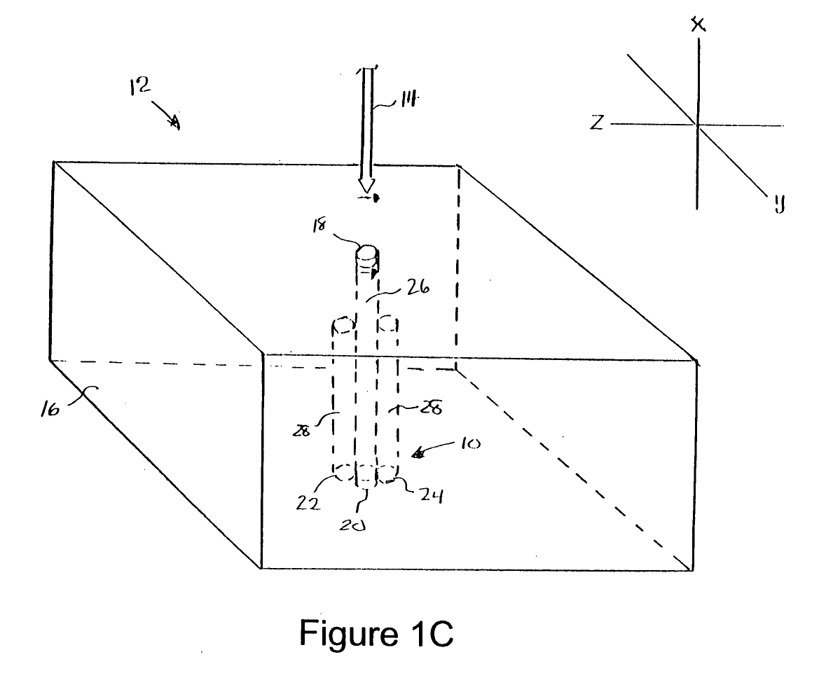

Referring to FIGS. 1A, 1B and 1C, there are shown various electrodes structures 10 usable in an optical cavity 12 receiving an optical signal 14. The present invention will be described in relation to a Fabry-Perot optical cavity but other embodiments of the optical cavity of the present invention may be configured for optical devices. The optical cavity 12 has an electro-optic material 16 disposed between opposing optically reflective materials 18 and 20. The electro-optical material may be formed from inorganic and organic materials, such as Potassium Titanyl Phosphate (KTP), Rubidium Titanyl Arsenate (RTA), Rubidium Titanyl Phosphate (RTP), Zinc Telluride (ZnTe), DimethylAmino-methyl Stilbazolium Tosylate (DAST) or other electro-optic materials, such as electro-optic polymers, all having the property of a changing index of refraction in response to an applied electro-magnetic field. The inorganic and organic materials have crystallographic axes defining the crystallographic structure of the electro-optic material 16. Crystals systems are cubic, tetragonal, orthorhombic, monoclinic and triclinic. The crystallographic axes for the cubic, tetragonal and the orthorhombic systems are mutually perpendicular to each other. The monoclinic and triclinic crystal systems have one or more of the crystallographic axes at oblique angles to each other. The hexagonal crystal system has two crystallographic axes falling on the same plane at 120° to each other and a third axis orthogonal to the other two. The inorganic and organic materials further have X, Y and Z optical axes which may or may not coincide with the crystallographic axes.

The optical cavity 12 will be described below in relation to inorganic KTP electro-optic material having an orthorhombic crystalline structure and optical axes coincident with the crystallographic axes. It is understood that the optical cavity 12 of the present invention is applicable to the other crystal structures and organic polymers having one or more optical axes that are responsive to an electro-magnetic field for changing the index of refraction of the electro-optic material. Further, the present invention will be described in relation to specific optical axes of the KTP electro-optic material 16 and a specific orientation of a propagating optical signal 14 and orientations of the electro-magnetic field within the KTP electro-optic material 16. In the preferred embodiment, the KTP electro-optic material 16 is an X-cut crystal face where the cleaved and polished surfaces of the crystal are perpendicular to the optical X-axis. Alternatively, the KTP electro-optic material 16 may be a Y-cut crystal face. The X-cut crystal is preferred over the Y-cut crystal for minimizing distortions from the acoustic modes generated within the electro-optic material 16. It should be noted that the electro-optic properties of other crystallographic structures may result in the preferred cut crystal face being orthogonal to the optical Z-axis producing a Z-cut crystal face.

The optical signal 14 provided to the optical cavity 12 is preferably provided by a coherent optical source, such as a laser diode or the like. The optical signal 14 is polarized as either linear or circular polarized light. The optical signal preferably passes through bulk optic lenses to provide a generally collimated or focused beam onto the optically reflective materials 18. An example of a generally collimated optical signal 14 focused on an electro-optic material is a 1310 nm optical signal having an optical path diameter ranging from approximately 15 to 150 microns. Other optical path diameters may be used with the electrode structure of the present invention. The linear or circular polarization states of the optical signal 14 are normal to the propagation direction of the signal. The lateral dimensions of the optically reflective materials 18 and 20 should exceed the beam diameter of the optical signal 14 impinging on the optical cavity 12. In the embodiments of FIGS. 1A, 1B and 1C, the optically reflective materials 18 and 20 generally conform to the diameter of the optical path and are formed on the X-cut crystal faces of the electro-optic material 16. The optically reflective materials 18 is partially reflective to allow the optical signal 14 to enter and exit the optical cavity 12. In certain applications the optical reflective material 20 is preferably totally reflective causing the optical signal to enter and exit through the same optically reflective material 18. The optically reflective materials 18 and 20 are preferably ceramic mirrors formed from layers of zirconium dioxide, silicon dioxide and silicon nitride. It is important in certain applications that the optically reflective materials be non-metallic to reduce capacitive and inductive effects.

The change in the index of refraction of the electro-optic material 16 in the presence of an electromagnetic field is a function of the orientation of the optical signal propagating in the electro-optic material 16 and the relationship of the polarization state of the optical signal 14 and the electrode structures 10 to the optical axes of the electro-optic material 16. For example, KTP electro-optic material exhibits the highest index of refraction and largest sensitivity response to an electro-magnetic signal when the polarization state of the optical signal 14 and the electro-magnetic field are parallel with the optical Z-axis of the KTP material. However, the KTP electro-optic material exhibits the highest piezoelectric response along the Z-axis, and the lowest piezoelectric response along the X-axis, when the electromagnetic field is parallel to the optical Z-axis. The piezoelectric effect causes a change in the refractive index of the crystal, but also physically alters the length of the material (or strain) along the three principle crystal axes. To minimize the effect of the piezoelectric strain on the modulated signal, it is desirable to ensure that the smallest change in crystal length occurs along the crystal axis that is perpendicular to the two cavity mirrors attached to the crystal. Therefore, in the preferred embodiment, the polarization state of the optical signal 14 and the electro-magnetic field are parallel with the optical Z-axis, and the optical beam propagates through the crystal parallel to the X-axis to minimize the effects of the acoustic modes in the KTP electro-optic material on the resulting optical modulation.

The electrode structures 10 in FIGS. 1A, 1B and 1C have a pair of apertures 22 and 24 formed in at least one of the optically reflective materials 18 and 20 and the KTP electro-optic material 16 that are generally parallel to the optical path 26 of the received optical signal 14 propagating through the electro-optic material 16. The KTP electro-optic material 16 has mutually perpendicular optical axes X, Y and Z that coincide with the crystallographic axes of the KTP material. The apertures 22 and 24 are disposed on the opposite sides of the optical path 26 of the propagating optical signal 14 and are oriented parallel to the optical X-axis of the electro-optic material 16. The apertures 22 and 24 are preferably formed as close as possible to the propagating optical signal 14 with the aperture separation, for example, being in the range of 45 to 120 microns. In some applications, the apertures 22 and 24 may extend into the optical path 26 of the propagating optical signal 14. The apertures 22 and 24 in FIG. 1A have a polygonal sectional shape with an apex directed toward the optical path 26 of the propagating optical signal 14. The apexes of the polygonal shapes concentrates the electromagnetic field across the optical path 26, which is parallel to the optical Z-axis of the electro-optic material. The polygonal electrode structure does not lend itself to usual manufacturing processes whereas a circular electrode structure as illustrated in FIG. 1B is easily produced. The circular apertures 22 and 24 in FIG. 1B have the same orientation with the optical path as in FIG. 1A. The circular apertures 22 and 24 are produced using an excimer pulsed laser that can produce apertures of approximately 100 microns in diameter and of varying depth in the electro-optic material 16. The circular apertures 22 and 24 in FIG. 1C are shown extending part way through the electro-optic material 16 and have the same orientation with the optical path in FIG. 1B. The blind hole apertures reduce the risk of damage to the optically reflective material 18 and 20 when the pulsed laser light from the excimer laser reaches the opposite end of the optical cavity 12. The aperture configurations of FIGS. 1A-1C are but three examples and other aperture configurations are possible without departing from the scope of the invention.

Electrically conductive material 28 is disposed within each of the apertures 22 and 24. The electrically conductive material 28 may take the form of conductive wires shaped to conform to the apertures 22 and 24, conductive material deposited on the inner surfaces of the apertures, conductive epoxy filling the apertures, or the like. The deposited conductive material is preferably gold plated over a layer of chromium. The electrically conductive material 28 preferably extends to the exterior surface of the one of the optically reflective materials 18 and 20 to allow the electrode structure 10 to be electrically coupled to an electro-magnetic source, such as a voltage source. Alternately, the electrically conductive material 28 may be connecting terminals for the voltage source where the ends of the terminals are inserted into the apertures 22 and 24. In a further alternative, the electrically conductive material 28 may reside totally within the electro-optic material 16 and the connecting terminals are inserted into the apertures 22 and 24 to make contact with the electrically conductive material 28. Forming the electrode structure 10 within the optical cavity 12 decreases the distance between the electrodes thus increasing the strength of the electric field applied across optical path 26 of the propagating optical signal 14. This increases the sensitivity of the electro-optic material 16 to the applied electric field.

In a specific embodiment where the electrically conductive material 28 is an electrically conductive epoxy, the apertures 22 and 24 extend through the optical cavity 12 and the electrically conductive epoxy fills the apertures 22 and 24. Filter paper is positioned on one side of the optical cavity 12 covering the apertures 22 and 24. A vacuum is applied to this side of the optical cavity 12 and the electrically conductive epoxy is applied to the apertures 22 and 24 on the other side of the optical cavity 12. The vacuum causes the electrically conductive epoxy to be drawn into the apertures 22 and 24. The filter paper prevents the electrically conductive epoxy from being drawn out of the apertures 22 and 24.

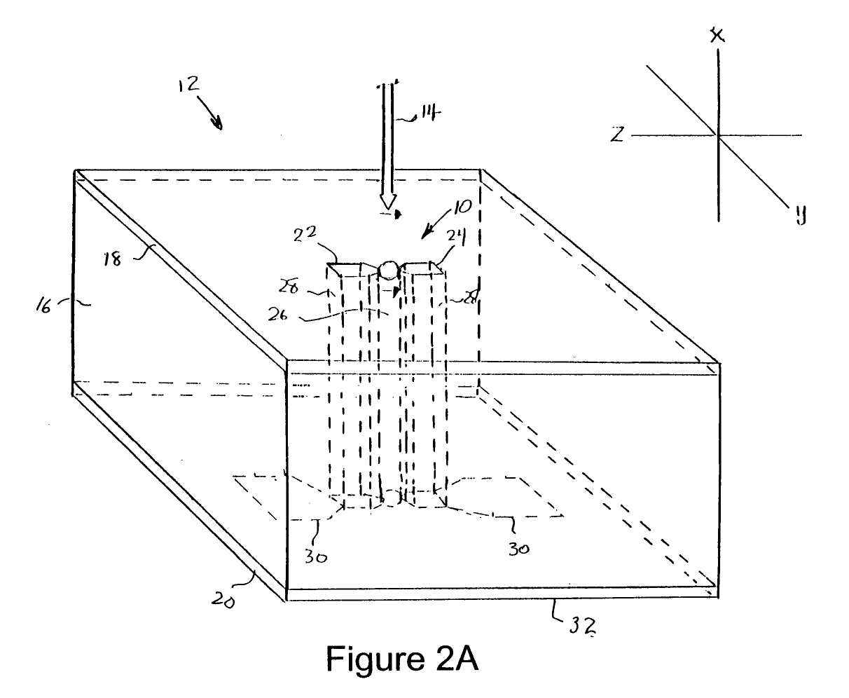

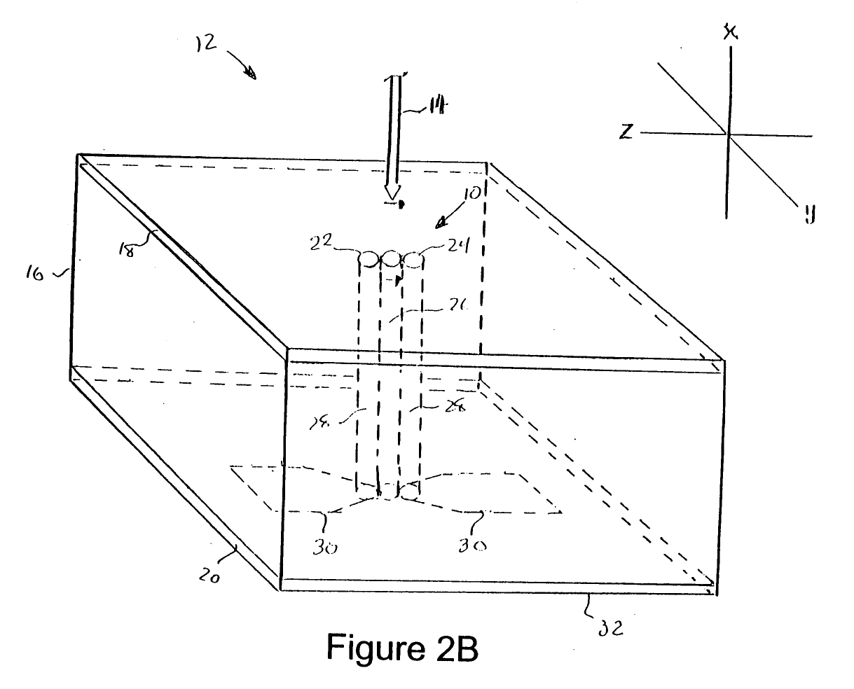

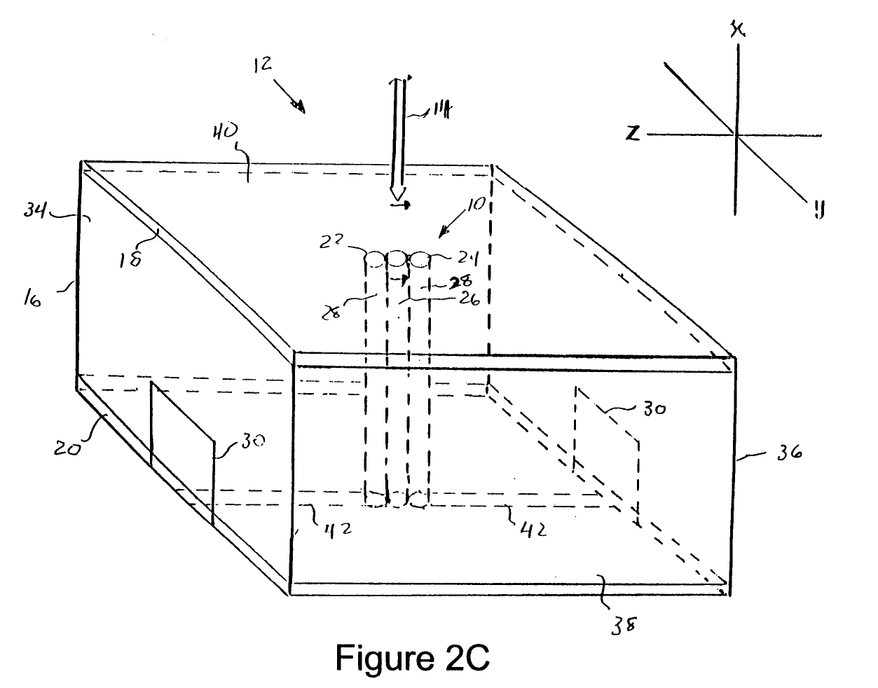

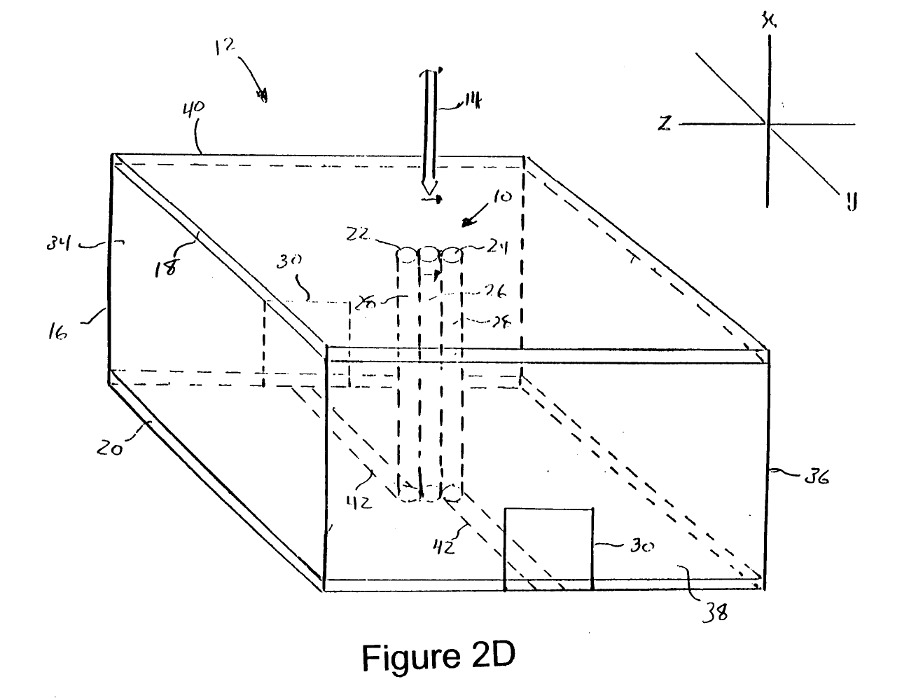

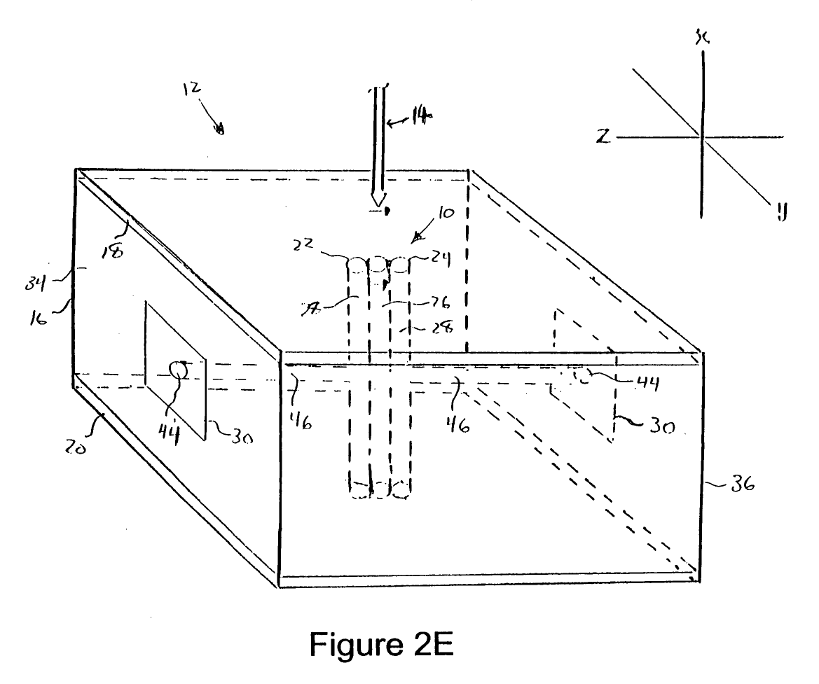

FIGS. 2A through 2E illustrates alternative electrically conductive contact 30 configurations in the electrode structure 10 of the present invention. The electrically conductive contacts 30 may be formed using well know deposition techniques, such as thin and thick film processes. The electrically conductive contacts 30 are preferably formed of gold deposited over a layer of chromium. In FIGS. 2A and 2B, the electrically conductive contacts 30 are formed on the same exterior surface 32 of the optically reflective material 20 with each contact 30 in electrical contact with the electrically conductive material 28 in one of the respective apertures 22 and 24. The electrically conductive contacts 30 are preferably a polygonal shape with an apex electrically coupled to the respective electrically conductive materials 28 in the apertures 22 and 24. In the preferred embodiment, the separation between the electrically conductive contacts 30 is in the range of 15 to 100 microns with the apertures 22 and 24 set slightly back from the apexes of the contacts 30. In FIGS. 2C and 2D, the electrically conductive contacts 30 are formed on opposing exterior surfaces 34, 36 and 38, 40 of the electro-optic material 16. Conductive traces 42 electrically couple the electrically conductive material 28 of the respective apertures 22 and 24 to the electrically conductive contacts 30 on the opposing surfaces 34, 36 and 38 and 40. While the figures illustrate the electrically conductive contacts 30 being on opposing surfaces of the electro-optic material 16, the electrically conductive contacts 30 may be formed on adjacent surfaces of the electro-optic material 16. As with the electrically conductive contacts 30 formed on the same surface, the apertures 22 and 24 intersect the conductive traces 42 with the separation between the conductive traces at the apertures 22 and 24 being in the range of 15 to 100 microns. FIG. 2E illustrates a further configuration for the electrically conductive contacts 30. Apertures 44 are formed in the electro-optic material 16 that intersect the respective electrode structure apertures 22 and 24. Electrically conductive contacts 30 are formed on the surface or surfaces of the electro-optic material 16 that intersect the apertures 44. Electrically conductive material 46 is disposed in the apertures 44 that electrically couples the electrically conductive contacts 30 to the electrically conductive material 28 in the apertures 22 and 24.

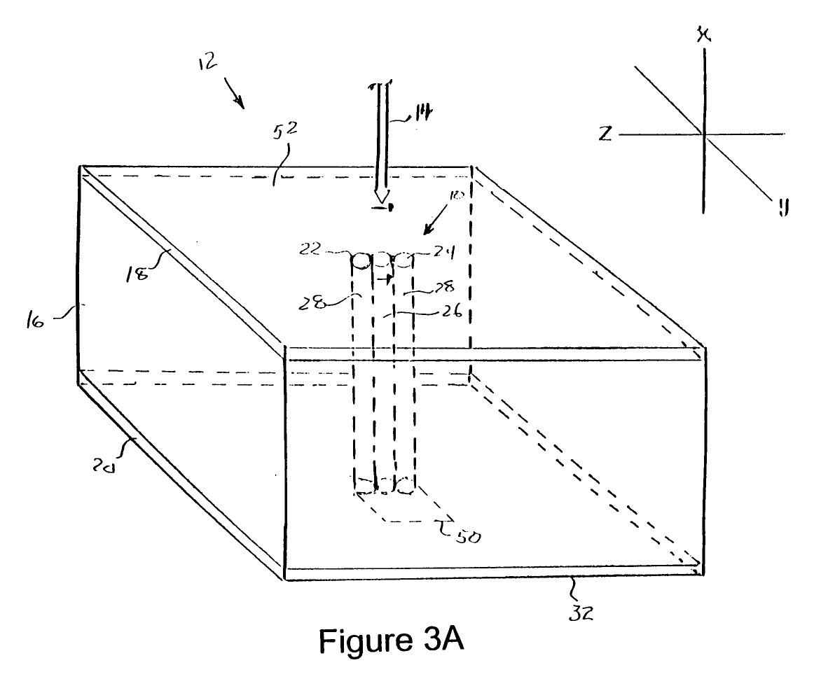

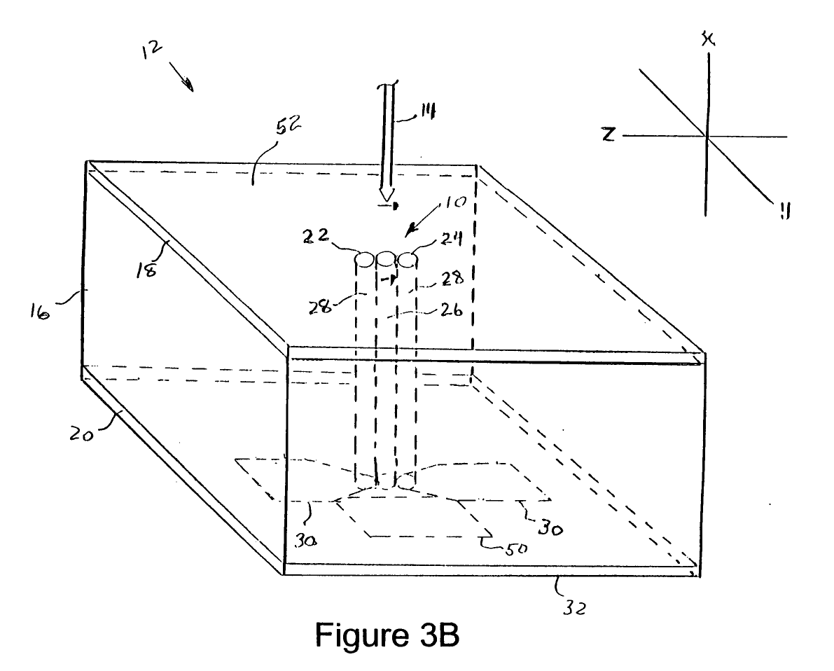

FIGS. 3A and 3B illustrate further embodiments of the optical cavity 12 of the present invention. The electrode structure 10 described has an high input impedance. In certain applications it may be preferable to match the impedance of the electrode structure 10 to the impedance of the device providing the electro-magnetic energy to the electrode structure 10. In FIG. 3A, an optional termination resistor 50 is shown formed on exterior surface 32 of the optical cavity 12 that is perpendicular to the apertures 22 and 24. The termination resistor 50 is connected between the electrically conductive materials 28 in the apertures 22 and 24 of the optical cavity 12. The termination resistor 50 may be formed using well known processing techniques, such as thin or thick film processing. The resistance of the termination resistor 50 is set to match the impedance of the device driving the optical cavity 12. The termination resistor 50 may also be formed on exterior surface 52 of the optical cavity 12 where the apertures are formed as through holes in the electro-optic material. In FIG. 3B, the optional termination resistor 50 is shown connected between the electrically conductive contacts 30 on the exterior surface 32 of the optically reflective material 20. In the embodiments where conductive traces 42 couple the electrically conductive contacts to the electrically conductive materials 28 in the apertures 22 and 24, the termination resistor 50 may be coupled to the conductive traces 42.

An optical cavity has been described having increased sensitivity. The optical cavity has an electrode structure disposed within the optical cavity having substantially parallel apertures filed with an electrically conductive material. The apertures are substantially parallel to an optical path of an optical signal propagating through the optical cavity. Electrically conductive contacts maybe disposed on the exterior surface of the optical cavity and electrically coupled to the electrically conductive material within the apertures.

It will be obvious to those having skill in the art that many changes may be made to the details of the above-described embodiments of this invention without departing from the underlying principles thereof. The scope of the present invention should, therefore, be determined only by the following claims.

1. An optical cavity receiving an optical signal comprising:
an electro-optic material disposed between opposing optically reflective materials;
a conductive electrode structure having first and second apertures formed in at least one of the opposing optically reflective materials and at least a portion of the electro-optic material generally parallel to the received optical signal propagating within the electro-optic material; and
electrically conductive material disposed within the first and second apertures.

2. The optical cavity as recited in claim 1 further comprising a resistor coupled between the electrically conductive materials disposed within the first and second apertures.

3. The optical cavity as recited in claim 1 further comprising electrically conductive contacts formed on an at least one exterior surface of the electro-optic material and optically reflective materials with the one of the electrically conductive contacts electrically coupled to the electrically conductive material disposed in the first aperture and the other electrically conductive contact electrically coupled to the electrically conductive material disposed in the second aperture.

4. The optical cavity as recited in claim 3 further comprising a resistor coupled between the electrically conductive contacts.

5. The optical cavity as recited in claim 3 wherein each of the electrically conductive contacts is formed on a separate exterior surface of the electro-optic and optically reflective materials.

6. The optical cavity as recited in claim 1 wherein the first and second apertures are disposed adjacent to the received optical signal propagating within the electro-optic material.

7. The optical cavity as recited in claim 1 wherein the received optical signal propagates generally parallel to at least a first optical axis in the electro-optic material with the first and second apertures generally parallel to same optical axis.

8. The optical cavity as recited in claim 1 wherein the electro-optic material has X, Y, and Z optical axes and corresponding crystal faces orthogonal to the respective X, Y, and Z optical axes with the optical cavity further comprising the opposing optically reflective materials being disposed on the Y-crystal face and the first and second apertures being orthogonal to the Y-crystal face of the electro-optic material.

9. The optical cavity as recited in claim 8 wherein the X, Y and Z optical axes are mutually perpendicular.

10. The optical cavity as recited in claim 1 wherein the electro-optic material has X, Y, and Z optical axes and corresponding crystal faces orthogonal to the respective X, Y, and Z optical axes with the optical cavity further comprising the opposing optically reflective materials being disposed on the X-crystal face and the first and second apertures being orthogonal to the X-crystal face of the electro-optic material.

11. The optical cavity as recited in claim 10 wherein the X, Y and Z optical axes are mutually perpendicular.

12. The optical cavity as recited in claim 1 wherein the electro-optic material has X, Y, and Z optical axes and corresponding crystal faces orthogonal to the respective X, Y, and Z optical axes with the optical cavity further comprising the opposing optically reflective materials being disposed on the Z-crystal face and the first and second apertures being orthogonal to the Z-crystal face of the electro-optic material.

13. The optical cavity as recited in claim 12 wherein the X, Y and Z optical axes are mutually perpendicular.

14. The optical cavity as recited in claim 1 wherein the electro-optic material and the optically reflective materials further comprise a Fabry-Perot etalon.
